(19) United States
(12) Patent Application Publication
(10) Pub. No.: US 2025/0045855 A1
(43) Pub. Date: Feb. 6, 2025

(54) SYSTEM AND METHOD FOR GENERATING POLICE AND EMS REPORTS USING ARTIFICIAL INTELLIGENCE PROMPTS

(71) Applicant: ERIC ALEXANDER CLAGUE, ST. PETERSBURG, FL (US)

(72) Inventor: ERIC ALEXANDER CLAGUE, ST. PETERSBURG, FL (US)

(21) Appl. No.: 18/791,323

(22) Filed: Jul. 31, 2024

Related U.S. Application Data
(60) Provisional application No. 63/517,430, filed on Aug. 3, 2023.

(51) Int. Cl. G06Q 50/26

(52) U.S. Cl. CPC G06Q 50/265

(57) ABSTRACT

A system and method for digitally generating police and/or EMS reports which can assist law enforcement and EMS personnel in generating accurate, consistent, and complete police and/or incident reports efficiently and consistently. In a non-limiting embodiment, the system can be an advanced AI-powered platform which can be configured and programmed to streamline report writing preferably in law enforcement and other first responder scenarios. The platform can be customizable for each user in order to meet any specific needs and reporting requirements of the user's organization, company, agency, etc. Customizable report templates can be provided and the system can recognize the specific agency templates to use based on the user's login which can include a specific key identifying the user's organization/agency.

This application claims the benefit of and priority to U.S. Application Ser. No. 63/517,430, filed Aug. 3, 2023, which application is incorporated by reference in its entirety herein for all purposes.

### BACKGROUND

Police officers and law enforcement agencies, as well as emergency medical services (“EMS”) responders, are often required to document incidents and generate detailed police reports and incident reports. The traditional process of manually writing police reports can be time-consuming, error-prone, and resource-intensive. As can be seen, there is a need for an efficient and accurate solution to streamline the report generation process while ensuring comprehensive and standardized reports.

The disclosed novel system and method are directing to overcoming or at least reducing one of the above issues experienced with manually created police and EMS reports.

### SUMMARY OF THE INVENTION

A novel system and method for generating police and/or EMS reports is disclosed and can streamline the process for creating such reports, while providing for more accurate reports and in a preferred embodiment can employ or otherwise use prompts from an artificial intelligence engine for creating such comprehensive reports. Through incorporating AI technology as part of the system, the novel system can assist law enforcement and EMS personnel in generating accurate, consistent, and complete police and/or incident reports efficiently and consistently.

In a preferred embodiment, the system can be an advanced AI-powered platform which can be configured and programmed to streamline report writing preferably in law enforcement and other first responder scenarios. The system can use artificial intelligence algorithms configured to generate comprehensive and accurate reports efficiently. The platform can be customizable for each user in order to meet any specific needs and reporting requirements of the user's organization, company, agency, etc. (collectively referred to as “organization”). As a non-limiting example, customizable report templates can be provided and the system can recognize the specific agency templates to use based on the user's login which can include a specific key identifying the user's organization/agency, etc. Thus, the provided templates provided for use to the user can be tailored to match the user's jurisdiction's standards and formatting guidelines. The system can be preferably accessed by a user through a desktop or laptop, as well as being designed to be mobile-friendly to allow officers/first responders to conveniently access, create, and review reports using the platform/system from their smartphones or tablets while in the field. The system can employ advanced natural language processing and AI algorithms to ensure accurate report generation, while still allowing the review, edit, approve and/or validate a proposed report for accuracy and completeness.

Accordingly, the system/platform provides for a method that requires a few steps to complete a comprehensive and accurate report (i.e. incident report, etc.) and thus saves the user valuable time in creating the report while also minimizing the risk of errors or omissions by the user. Tailored reports for the user's organization can create complying with specific report requirements for organization using customizable templates that can adhere to the standards and formats for the jurisdiction associated with the organization, thus, helping to ensure and consistency and professionalism for the report created using the system and method.

The novel algorithm, which can be AI-powered, is configured to understand and analyze the context of the user's input, which can result in providing intuitive report generation and enhancing overall quality of the report. As the report can be prepared and finalized in a significant reduced amount of time, as compared to prior manually created reports, the user can be provided with additional time to focus on other non-report tasks, while knowing that the report created using the disclosed novel system and method is timely and accurate.

Accordingly, the novel algorithm allows for automation of certain tasks normally involved for generating an incident report and can also sift and search through large datasets and databases to detect patterns or anomalies, which can support or enhance predictive policing/first responder efforts. With the disclosed novel system and method human errors can be reduced, if not minimized, to aid in providing reports that are accurate, consistent and in compliance with any requirements of the organization and which adhere to legal standards in order to be admissible for legal proceedings and investigations.

The novel algorithms of the disclosed system and method can also review and analyze report data for identifying trends, predicting potential crime hotspots and suggesting preventive measures that may be undertaken. Thus, the predictive analytics provided by the novel algorithm can contribute to proactive policing and first responder strategies, which may lead to a reduction in crime rates and an overall enhancement of community safety.

### BRIEF DESCRIPTION OF THE DRAWINGS

FIG. 1 illustrates a non-limiting, preferred process flow for digitally generating a report (i.e. police report) in accordance with the present disclosure;

FIG. 2 illustrates a non-limiting, preferred process flow for digitally generating a report from inputted information and an uploaded cam footage in accordance with the present disclosure;

FIG. 3 illustrates a non-limiting, preferred process flow for digitally generating a report from inputted information and an uploaded audio file or an audio file recorded using the present system in accordance with the present disclosure;

FIG. 4 illustrates a non-limiting, preferred process flow for digitally generating a report which also provides for user approval or editing of digitally transcribed data by the system prior to a full report being generated and also provides for the system to automatically alert the user where the system determines that the generated report is missing information or missing required information in accordance with the present disclosure.

FIG. 5 illustrates an image of a screenshot providing a non-limiting example of prompts/choices/modules for a police report for selection by a user based on the nature of the incident to be reported; and

FIG. 6 illustrates an image of a screenshot providing a template for the module/prompt chosen by the user, such as, without limitation, the choices shown in FIG. 5, and with the template preferably customized to comply with any specific requirements for reporting set forth by the organization that the user is associated with.

### DETAILED DESCRIPTION OF THE INVENTION

Broadly, a preferred, non-limiting embodiment for the novel system and method is described herein and will describe the system and method in connection with digitally creating a police report as the example report. However, the disclosed system and method are not limited to use for creating police reports, and the system and method can also be used for creating EMS and FireFighter reports (collectively “EMS”), as well as other reports and other first responder reports, based on templates, prompts, etc. programmed or provided in connection with these other types of reports and such other uses are also considered within the scope of this disclosure. The novel system and method allows for generating police reports in an efficient and consistent manner, which addresses some of the problems with manually created reports.

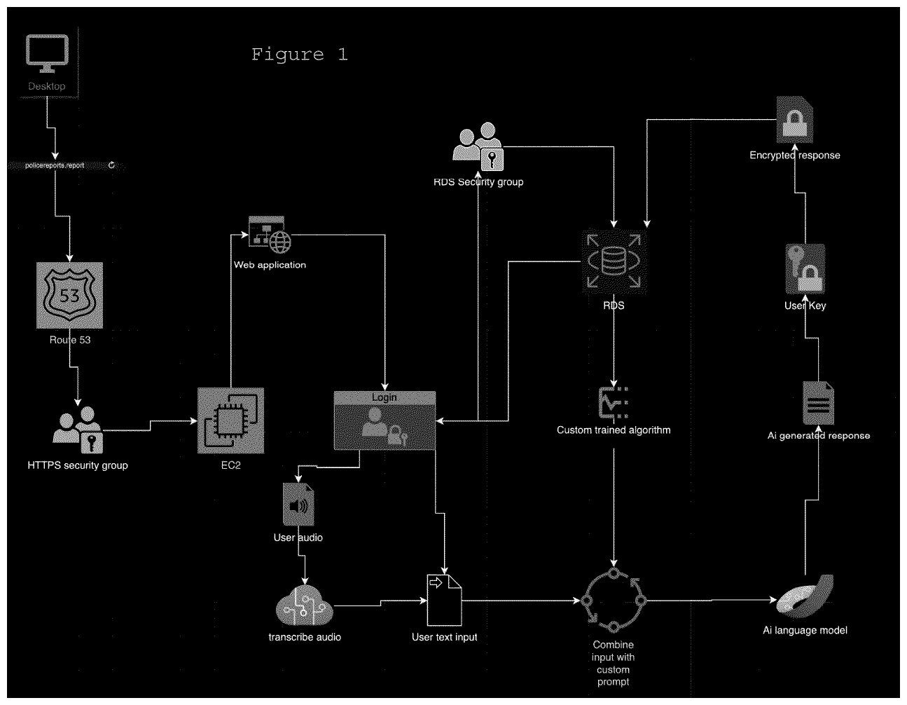

A general process flow for creating a police report is shown in FIG. 1. Initially, the user has to sign-in/login or otherwise access the system. One preferred, non-limiting secured user login scenario is shown in FIG. 1 and briefly described herein. In the non-limiting login scenario scene in FIG. 1, the system can be accessible online by a user and can be preferably subscription/membership based, though such is not considered limiting. Preferably, the system can be provided to users as an online platform, where users can access the platform by going to a registered domain associated with the platform (i.e. where the online platform resides online). A cloud computing service, such as, but not limited to, Amazon Web Services (“AWS”) can be used to link the domain to a server component of the system, and can check if the system is permitted to access it through HTTPS security group rules that have been previously setup/defined/configured/programmed, etc. Assuming access is allowed, the system can be connected to an Amazon Elastic Compute Cloud (EC2) in the AWS (as a preferred, non-limiting example) and the web application/program for operating the novel system can be loaded in.

After a user has logged into their preferably online account, the user can identify themself with their online/digital credentials and a specific encryption key for the agency they are associated with (e.g. specific police department, specific governmental agency, specific EMS company, etc.). In this screen or a subsequent screen that appears of the credentials and encryption key have been digitally entered, the user can be presented and/or chose one or more written prompts that have been previously configured/programed to be linked to specific criminal/law violations/crimes for the police report example (i.e. which could be various medical events or conditions or other information in an EMS report example).

Once the proper violation of the incident is digitally chosen by the user, a new online page of the user's screen can open where users can use voice dictation, audio uploads, video uploads and/or enter text as one or more methods to describe the incident. When information concerning the incident is uploaded and properly described, the user can accept the terms of service and/or the uploaded and incident description, which can cause the system to preferably combine and/or send the inputted/uploaded information with the selected prompt(s) linked to the violation to a trained large language model for further processing and handling of the information.

Preferably, the large language model can be previously provided/configured/programmed with any and all report format requirements of the specific agency associated with the user's encryption key and can be programmed to extract the inputted and/or upload information and generate an accurate report, specific to the format required and/or requested by the specific agency. Thus, the large language model can be programmed to extract and move around the inputted information and place such information in predefined areas required by the specific agency to automatically create an accurate and agency compliant report that the user can copy, print and/or download from the server.

The below non-limiting code example explains the steps of sending the incident details and selected prompt linked to the violation to the large language model and the generation of the accurate report.
Preferably, certain parts of the selected predefined prompt can be combined with the incident details
Non-Limiting Example prompt

The user can be an experienced police officer, who specializes in generating police reports.

The user can give the DESCRIPTION_HERE. The generated answer should preferably follow these following rules:
Provide a call to use EXAMPLE REPORT for formatting.
Use the DESCRIPTION_HERE AND EXAMPLE REPORT for a GENERATED ANSWER.
Do not add any detail in your GENERATED ANSWER if its not mentioned in given DESCRIPTION_HERE.
IF you don't find the any DESCRIPTION_HERE then just say “No Content available to generate report.”
Do not add any actions to the GENERATED ANSWER if not mentioned in DESCRIPTION_HERE.
Restructure the DESCRIPTION_HERE to a professional police report style format for the GENERATED ANSWER.
Make the GENERATED ANSWER much longer than the DESCRIPTION_HERE using middle school level English.
The GENERATED ANSWER should end with “EOR/NFI”.
Do not take names from the EXAMPLE REPORT and put them in the GENERATED ANSWER
Do not add dates and times to the GENERATED ANSWER from the EXAMPLE REPORT
Do not add locations to the GENERATED ANSWER from the EXAMPLE REPORT
Do not add any disclaimers to the GENERATED ANSWER
Do not add adverbs that appear to offer an emotional response from the officers point of view to the GENERATED ANSWER
Do not write a conclusion at the end of the GENERATED ANSWER

### Example Report Start:

Example Report from Agency Entered
The parts where the example says DESCRIPTION_HERE can be replaced with the incident details

Preferably, after being digitally sent to a large language model of the system, the LLM can look at the logic explained in the prompt, follow certain guidelines defined in the prompt and create an accurate written report.

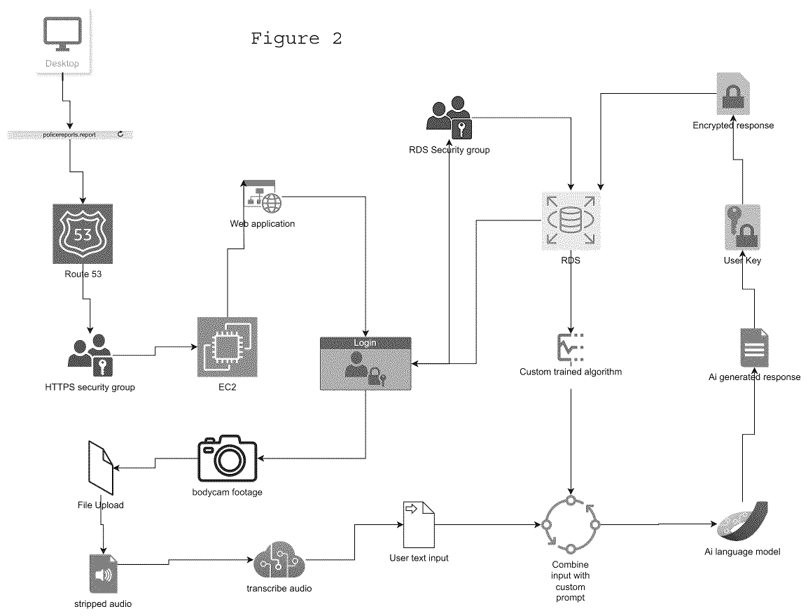

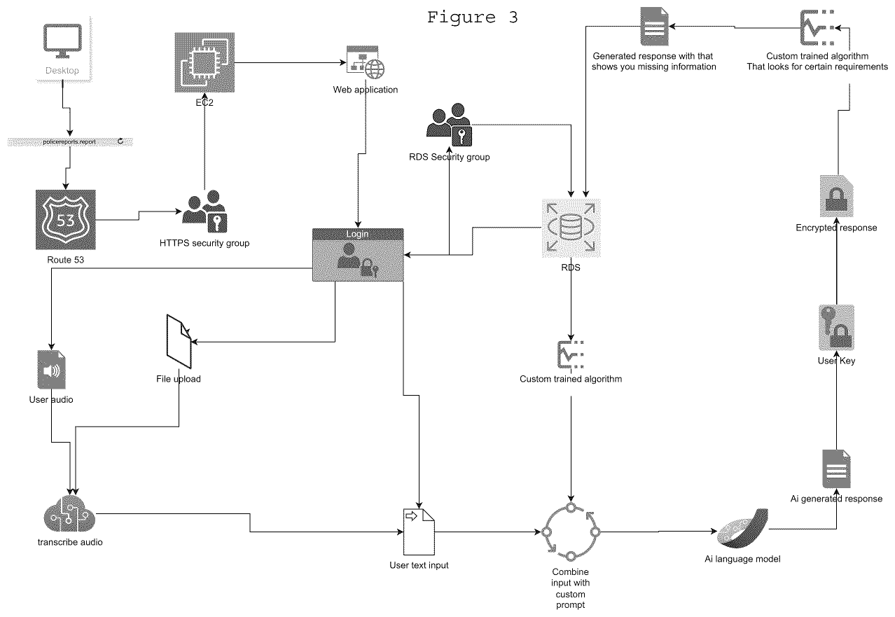

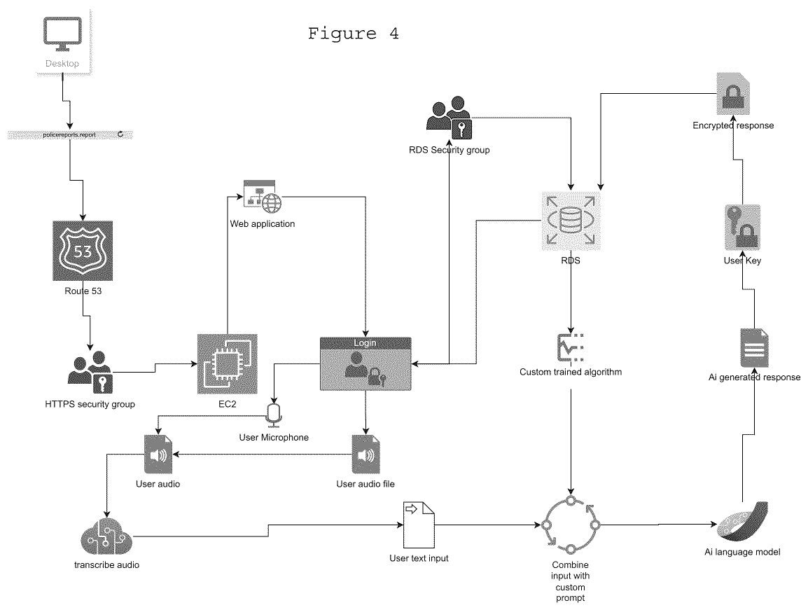

As seen in FIG. 2, a non-limiting process flow embodiment for uploading a file and generating a report using the disclosed system and method is illustrated. The above description for components and steps described above in connection with FIG. 1 that are also present in FIG. 2 (or FIG. 3 or FIG. 4) is considered to be incorporated by reference in its entirety for the same components/steps appearing in FIGS. 2, 3 and/or 4.

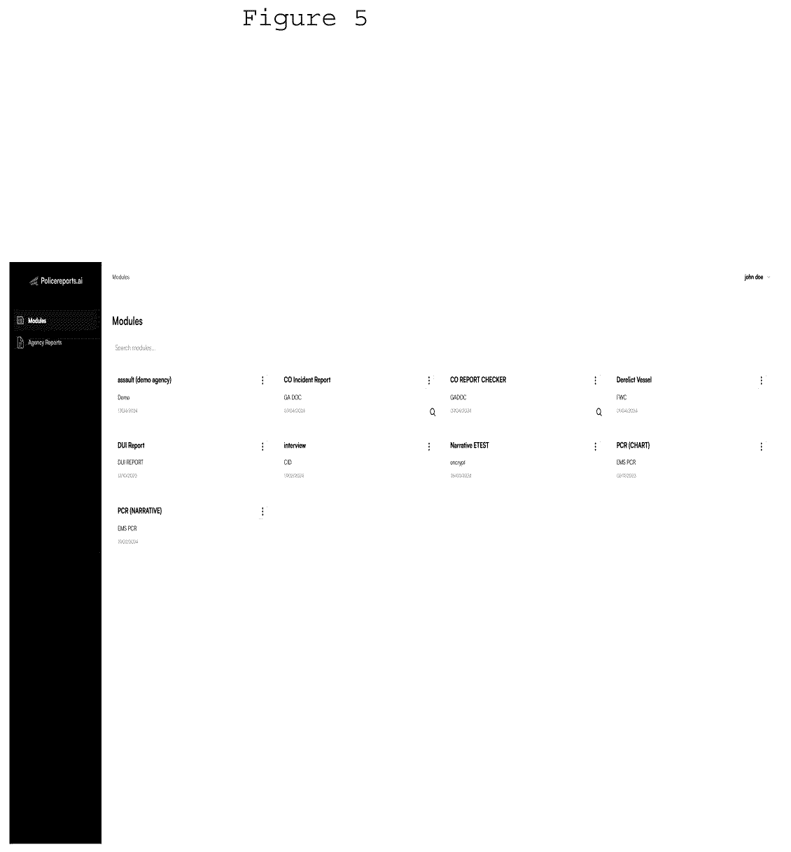

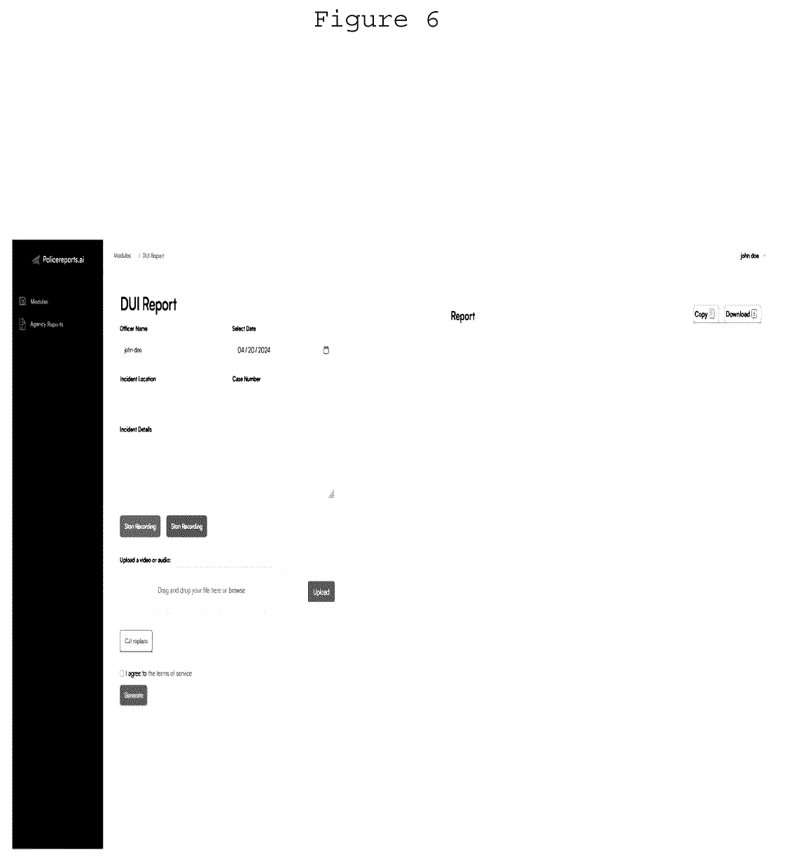

With respect to FIG. 2, the user preferably accesses a website or other online location (collectively “website”) where an online version of the system can be accessed for use in digitally/electronically creating a police report. Preferably, the user can be routed to one of the servers (e.g. ec2 machine, etc.) where the website can be preferably hosted. The user then logs in at a “sign in” page of the website, displayed on the user's screen preferably using their credentials. As seen in FIG. 5, after signing in, the system can display on the user's screen a choice of modules for the user to select which can include different types of crimes (i.e. DUI module, assault module, derelict vessel module, etc.) which may or may not ordinarily differ from each other in the type of information collected. Other non-specific crime modules can also be provided, such as, but not limited to, a report checker module, etc. The user then selects the module from the choices that matches or best matches the crime involved in the incident, which causes the system to automatically open and display a report page on the user's screen associated with the selected module (See FIG. 6).

As noted above, as part of their login credentials, the system can receive information or data about the specific organization that the user is associated with or is generating the report for, which will allow the system when opening up the report page for the selected module, to search for preloaded/preconfigured customized templates for the user's organization that are associated with the selected module and if found, the customized template for the organization can be opened and displayed on the user's screen for the report page.

With either a default report page or the user's organization's customized report page displayed on the user's screen, the user can then fill in any text information regarding the crime and upload their body cam footage. After uploading bodycam footage, the system can be programmed/configured to take (i.e. digitally strip/extract, etc.) the audio from the uploaded body cam footage file and/or another user uploaded video file and preferably electronically/digitally sends it to a large language model (“LLM”) or other software based system/program for transcription of the audio. The transcribed audio can then be preferably electronically/digitally returned/sent back to the user and can be displayed as text/data on the user's screen or printed out by the user to allow the user to read through the transcription and make any changes needed to the transcription prior to generating the final report. Preferably, the changes can be made by the user to the text/data on the user's electronic device screen and entered/saved by the user. The transcribed and proofed/approved data and module prompt can be electronically/digitally sent to the LLM or other software based system/program to digitally prepare and write the full report preferably in compliance with any specific requirements for the organization through presenting the user with an organization specific customized template for the module selected by the user. It should be noted, that in addition to or in lieu of bodycam footage, the user can also record audio at the website and the recorded audio can be sent to the LLM or other software based system for transcription (however as the recorded audio can be preferably just audio of the user speaking, the taking or extracting of the audio step described in FIG. 2 is not needed for the user speaking recorded audio (which is also described below in connection with FIG. 3).

Though not considered limiting, preferably a custom LLM, preferably exclusive for the novel system or a third pary machine learning model, including without limitation, the WHISPER machine learning model, or another transcription software program or digital technology vcan be used to reformat the voice or video data from the bodycam footage to preferably a MP3 format and then the LLM of the novel system can be used to transcribe the audio into various supported languages (e.g. English, Spanish, etc.). Preferably, multiple speakers on the bodycam footage can be differentiate by the LLM or other digital transcription technology by an inference of the conversation. It is also considered within the scope of the disclose to train or program the LLM to transcribe events from the bodycam footage just from viewing the video, whether or not the video also contains spoken words, audio and/or other sounds and noises.

With respect to FIG. 3, the user preferably accesses a website where an online version of the system can be accessed for use in digitally/electronically creating a police report. Preferably, the user can be routed to one of the servers (e.g. ec2 machine, etc.) where the website can be preferably hosted. The user then logs in at a “sign in” page of the website displayed on the user's screen, preferably using their credentials. As seen in FIG. 5, after signing in, the system can display on the user's screen a choice of modules for the user to select which can include different types of crimes (i.e. DUI module, assault module, derelict vessel module, etc.) which may or may not ordinarily differ from each other in the type of information collected. Other non-specific crime modules can also be provided, such as, but not limited to, a report checker module, etc. The user then selects the module from the choices that matches or best matches the crime involved in the incident, which causes the system to automatically open and display a report page on the user's screen associated with the selected module (See FIG. 6).

As noted above, as part of their login credentials the system can receive information or data about the specific organization that the user is associated with or is generating the report for, which will allow the system when opening up the report page for the selected module, to search for preloaded/preconfigured customized templates for the user's organization that are associated with the selected module and if found, the customized template for the organization can be opened up and displayed on the user's screen for the report page.

With either a default report page or the user's organization's customized report page displayed on the user's screen, the user can then fill in any text information regarding the crime and upload their prerecorded audio file or record a new audio file using the novel online system. After uploading the audio, the system can be programmed/configured to recognize that file is already just an audio file so that no stripping or extracting of audio from a file containing more than just audio is needed. The system can preferably electronically/digitally send the audio file to the LLM or other software based system/program for transcription of the audio. The transcribed audio can then be preferably electronically/digitally returned/sent back to the user and can be displayed as text/data on the user's screen or printed out by the user to allow the user to read through the transcription and make any changes needed to the transcription, prior to generating the final report. Preferably, the changes can be made by the user to the text/data on the user's electronic device screen and entered/saved by the user. The transcribed and proofed/approved data and module prompt can be electronically/digitally sent to the LLM or other software based system/program to digitally prepare and write the full report, preferably in compliance with any specific requirements for the organization through presenting the user with an organization specific customized template for the module selected by the user.

With respect to FIG. 4, the user preferably accesses a website where an online version of the system can be accessed for use in digitally/electronically creating a police report. Preferably, the user can be routed to one of the servers (e.g. ec2 machine, etc.) where the website can be preferably hosted. The user than logs in at a “sign in” page of the website, displayed on the user's screen preferably using their credentials. As seen in FIG. 5, after signing in, the system can display on the user's screen a choice of modules for the user to select which can include different types of crimes (i.e. DUI module, assault module, derelict vessel module, etc.) which may or may not ordinarily differ from each other in the type of information collected. Other non-specific crime modules can also be provided, such as, but not limited to, a report checker module, etc. The user then selects the module from the choices that matches or best matches the crime involved in the incident, which causes the system to automatically open and display a report page on the user's screen associated with the selected module (See FIG. 6).

As noted above, as part of their login credentials the system can receive information or data about the specific organization that the user is associated with or is generating the report for, which will allow the system when opening up the report page for the selected module, to search for preloaded/preconfigured customized templates for the user's organization that are associated with the selected module and if found, the customized template for the organization can be opened up and displayed on the user's screen for the report page.

With either a default report page or the user's organization's customized report page displayed on the user's screen, the user can then fill in any text information regarding the crime, upload their body cam footage, upload their prerecorded audio file, or record a new audio file using the novel online system. After uploading bodycam footage, the system can be programmed/configured to take (i.e. digitally strip/extract, etc.) the audio from the uploaded body cam footage or user uploaded video file, or takes the whole audio file (i.e. extracted from uploaded video and user recorded audio) and preferably electronically/digitally sends it to a large language model (“LLM”) or other software based system/program for transcription of the audio. The transcribed audio can then be preferably electronically/digitally returned/sent back to the user and can be displayed as text/data on the user's screen or printed out by the user to allow the user to read through the transcription and make any changes needed to the transcription prior to generating the final report. Preferably, the changes can be made by the user to the text/data on the user's electronic device screen and entered/saved by the user. The transcribed and proofed/approved data and module prompt can be electronically/digitally sent to the LLM or other software based system/program to digitally prepare and write the full report, preferably in compliance with any specific requirements for the organization through presenting the user with an organization specific customized template for the module selected by the user.

After digitally generating or digitally creating a report, the system can be programed or configured for the user to be able to have the system check the report to ensure that all required information is present in the report. In a preferred non-limiting embodiment, the user can click or select a check button appearing on the user's screen to initiate the system's check of the report, which can also load in another custom prompt that can tell the user if the generated report is missing information.

The “Custom Trained Algorithm” block appearing in the drawings can be considered the customized prompt, which can be provided/programmed/configured with one or more rules for operation, with the algorithm using such rules, the user inputted/uploaded/recorded incident details and the LLM to create a response/report. EMS and other reports can also be completed by filling out sections via data reorganized through the LLM.

The modules can be customized per organization/agency and/or type of crime/incident. For police reports, a plurality of organizations can all have modules for the most common crime types, and during setup or at a later time, the settings for a specific organization can be further updated to add new/additional modules for new crime types and/or one or more of the existing modules can be updated for specific information/data required by the specific organization.

The custom prompts can be the logic inside a module and is where the system informs the LLM what rules and information to use and combine with the user provided incident details.

The steps performed by the computer for combining the raw text input (regardless of origination—body cam, dictated, typed, etc.) with the custom prompt can include configuring the system to replace a specific placeholder inside a custom prompt with the incident details inputted or otherwise provided by the user/officer. As a non-limiting example:
DESCRIPTION_HERE can be replaced with the user provided incident details.

The relational database service (“RDS”) for the cloud computing (e.g. Amazon Web Services—AWS, etc.) preferably used for the system and method can be where the method/process performed by the system ends. When the report is completed and preferably encrypted by the system, the report can be preferably be saved to the database and the user can be provided the option by the system to generate another report without having to start the complete process again.

As noted above, the system preferably incorporates or uses a LLM or back end prompting in connection with performing the novel steps in creating or generating the reports. Preferably, the LLM can be custom and specific to the novel system as opposed to a general LLM. The custom LLM can be hosted on a foundation model, such as, but not limited to, AWS Bedrock. The disclosed preferably has sole access to the LLM (i.e. the LLM is not shared with anyone else), which is unlike common AI applications like Chat-GPT. The custom prompts used by the system can be used by the system for generating reports, for checking reports, or for reorganizing video into reports.

Preferably through the use of AI, the system can also auto caption reports via extensions, such as, but not limited to, chrome extension. As such, in addition to completing the text portion the system can also complete the dropdown portion, to further reduce the time needed to complete a typical entire report to just a few minutes (i.e. around 3 minutes).

In a preferred embodiment, the system can comprise one or more, and preferably all, of the following components:

Artificial Intelligence Prompt Engine: The disclosed novel system can feature or include an AI prompt engine that can employ natural language processing algorithms and machine learning techniques to capture relevant data from an officer-generated written synopsis. For example, the engine can analyze the officer-generated synopsis to automatically and quickly generate context-specific prompts and questions based on the information within the office-generated synopsis. The system can also automatically analyze any available body camera footage provided by the user to generate additional prompts. For example, by analyzing information concerning the incident type, location, or relevant details provided by the individual police officer the AI prompt engine can automatically generate prompts to ensure the officer (or other user) enters all relevant information needed for a particular police report.

The AI prompt engine can present a series of context-relevant questions and prompts to the user based on the entered incident information synopsis and/or body camera information. These prompts can then guide the officer to ensure that all pertinent aspects of the incident are captured that are necessary for the report generation process.

By way of example, an API key from a custom hosted LLM or cloud based LLM can be obtained and code (such as that provided below as a non-limiting example) could be used to implement certain aspects of the disclosed system and method.

Data Input Interface: As discussed above, law enforcement personnel can interact with the system through a user-friendly data input interface. A synopsis can be entered preferably containing certain incident information, such as, but not limited to, the date, time, location, involved parties, witnesses, and other evidence details. As also noted above, the system can also gather footage from the body camera device worn by the officer (if applicable) and other recorded audio/video, and the AI engine can transcribe the camera information and/or videos or photos to text to be included in the incident report as appropriate and in compliance with any requirements for the particular organization that the user is associated with.

Automated Data Organization: The system can be configured to automatically organize the gathered information into appropriate sections of the police report, such as incident description, witness statements, suspect details, evidence inventory, and officer's observations, by way of non-limiting example.

Report Generation Engine: Once all necessary information is inputted and/or uploaded and the prompts generated by the system based on the information it received from the user are answered, the system can be configured to compile the data into a cohesive, comprehensive and standardized police report format or customized report specific for the user's organization, ready for further review and submission as necessary.

Customizable Templates: The system can be configured to offer customizable report templates, allowing law enforcement and/or other agencies to tailor the prompts and report formats according to their specific requirements and/or the requirements of the organization that the user is associated with (e.g. user's police department, etc.).

Data Security and Access Controls: The system can incorporate robust data security measures, ensuring the confidentiality and integrity of sensitive information. Access controls can restrict report editing and viewing privileges to authorized personnel only.

A back-end prompt of the present system can be added and/or modified to be specific to a particular organization/agency or user.

Though not limiting or exhaustive, the disclosed novel system and method offers several advantages over traditional manual report writing methods which can include:

Time and Resource Efficiency: The AI-driven prompt system accelerates report generation, reducing the time and resources required for documentation.

Consistency and Standardization: The system ensures standardized reports by following a structured template and capturing all relevant details through guided prompts.

Accuracy and Completeness: The AI prompts help avoid omissions and errors that may have contained within a manually written report, resulting in accurate and comprehensive police reports.

Customizability: The customizable templates cater to the specific needs of different law enforcement agencies/organizations.

Though not considered limiting, the following servers are examples of servers that can be used with the disclosed novel system and method, AWS, EC2, RDS and/or Bedrock LLM servers, though other servers that can provide the functions and capabilities needed for creating the reports described herein can be used and are also considered within the scope of the disclosure.

Additionally, where EC2 and/or RDS servers are employed, preferred, non-limiting instance minimal characteristics/requirements for the servers can comprise:
EC2-instance minimal requirements
   1 Vcpu
   2 cores
   1 GB ram
   20 GB storage
   Amazon linux 2
   Nginx
   PHP 8
RDS instance
   1 vcpu
   1 core
   4 GB ram
   MySQL

Accordingly, the disclosed system and method provide for a novel solution primarily directed to public safety and/or public service organizations, though such is not considered limiting, and the system can be configured to also generate reports for other types of organizations. With use of the herein described novel system and method the creation of a large array of reports and documentation for public service agencies can be automated and the system allows users to create or generate reports specific or customized for a particular organization/agency.

The software and algorithms used by the system can be continuously updated, and the system configurations can be continuously updated, to incorporate the latest advancements in natural language processing and machine learning, as well as the client/user organizations' changing policies and procedures. The system and software can be specifically customizable and configured for every client/user/organization, incorporating the organizations'/agencies' adopted/required/suggested policies, procedures, and other specific nuances to the generated output.

The system software can use Client-Side Encryption which can provide for a high or highest level of security and privacy by encrypting data on the client side, providing an additional layer of protection for sensitive information. The system operating software can be provided as a free-standing platform such that users are not required to purchase other programs and the disclosed system software can complement current programs in place. With proper cooperation, the system software can be relatively easily integrated into third party companies, such as record management systems and other software, maintaining workflows, and minimizing disruption for agencies/organizations and their end users.

Preferably, once the user logs into the disclosed novel system with their credentials, the end user can be presented with a digital online dashboard displayed on their computer or electronic device screen with the dashboard preferably being specific to his or her agency/organization and account settings. Each agency/organization can be provided the ability to create custom modules, based on common report types, as well as agency/organization policy and procedure and desired report format. Once signed in, the end user can select the most appropriate module from a list of modules displayed on their screen to generate their desired report. Once electronically/digitally inside of the selected module, the user can be provided with several options to generate the report.

One of the methods for an end user to generate reports is through a voice dictation feature of the system/system software. In one non-limiting embodiment, to use the voice dictation feature, the end user can click a “Start Recording” Button and then begin to converse with the system/software (i.e. through a microphone component of their computer/electronic device, etc.) and verbally provide/speak the details in his or her own words of the incident. Once completed, the end user can click a “Stop Recording” button. Once this button is selected, the system can be configured to employ a transcription program/technology, that can be specifically tailored for public safety and public service agencies in one non-limiting embodiment, to convert the end user's dictated speech into text/text file. Once converted, the system can be configured to display the text in a box or other area of the user's screen, where the text can be preferably both viewable and editable by the end user. After reviewing the content for accuracy and content and making any edits to the text deemed needed by the user, the end user can then digitally agree to terms of service and initiate the digital generation/creation of the incident report.

The system can be configured to use natural language processing and machine learning to generate the report, based on the information inputted by the end users using his or her computer/electronic. As the organization/agency format requirements are already preconfigured defined and saved in the system, when the system generates the report, the report can be customized and in compliance with the agency's/organization's desired format. Once the report is generated, it can be displayed on the user's screen or otherwise electronically presented to the user and the user can be given the ability to review and edit the generated report if necessary, using his or her computer/electronic device.

In addition to or alternatively to the above-referenced voice dictation method, the system can be configured to allow the end user to upload a previously recorded audio file, documenting the details of the desired report generation. Within the desired selected module, the end user has the ability to import any format of audio file. Once uploaded, the audio file can be similarly transcribed as discussed above and the audio filed converted into text/text file for viewing and any editing by the end user. Similarly, once reviewed and edited, if necessary, the end user then follows the same or similar steps of agreeing to the terms of service, and selecting to generate a report, causing the system to use the above-referenced natural language processing and machine learning to generate a report into a desired agency format.

In addition to or alternatively to the above-referenced voice dictation and/or audio upload features, the system can be configured to analyze various types of video footage, such as, but not limited to, body camera, covert video, or surveillance camera footage, and extract out an audio portion from the video which can then be converted to text/text file for similar handling and report generation/review/editing as described above for the voice dictation and audio file upload scenarios.

In addition to electronically generating the incident report, the system can also be configured to employ agency specific checkers, allowing end users to verify the report for completeness and accuracy, preferably in accordance with the user's agency's/organization's policies, procedures and/or practices. To electronically/digitally initiate the checkers, once the report is generated and reviewed by the end user, the end user can select a “check” on his or her computer/electronic device screen. The system/system software can be configured to analyze the content of the generated report, based on specific predefined/preconfigured factors desired by the agency/organization. Once the report is analyzed the system can be configured to digitally/electronically respond to the end users with details such as missing content, necessary agency codes, and other factors. The end user then has the ability to add to or make necessary changes to the generated report, based on the checker's analysis. With any needed changes/additions made, by way of either extension or endpoint with a third party software application/program, a JSON file can be completed and the report along with appropriate fields can be filled out within a specific records management system of the agency/organization, or agency specific forms and documents. Thus, the generated report can then be digitally/electronically sent to the agency/organization, where the information from the report can be automatically digitally/electronically extracted into appropriate fields of the agency's/organization's records management system.

In addition to report generation, the system can be preferably configured to comprise other modules with the ability to provide specific and customizable analysis of data, such as phone calls, text messages, agency reports, interviews, and interactions with the public. These other types of data can be digitally/electronically submitted/inputted/uploaded into the system at the user's screen in the same or similar manner as described above for report generation (video, audio, etc.). Accordingly, the system can analyze and synthesize complex data which can increase efficiency for end users in providing necessary services.

The system can be configured to operate in multiple languages and can translate the input and output text into these multiple languages desired by the end user.

As seen from the above-description, through the use of the novel system and method, the report can be generated using a significant reduction of the user's actual time. Additionally, certain aspects of the described system and method, such as, but not limited to, extracting an audio file out of an uploaded video file, etc. are not capable of being performed manually. Accordingly, the novel system and method can significantly reduce the manual effort commonly employed by end users in these fields and increases accuracy, effectiveness, and worker satisfaction.

The below non-limiting computer code for the novel algorithm in accordance with the present disclosure is included by way of example only and intended to be exemplary of how the novel system and steps performed by such system can be designed and implemented in accordance with the principles of the current disclosure. However, an API key from chat GPT could also be obtained and the following code could be used in python to implement certain aspects of the disclosed system and method and such implementation is also considered within the scope of the disclosure.

```
from flask import Flask, render_template, request
from Cryptodome.Cipher import AES
from Cryptodome.Util.Padding import pad, unpad
from discordWebhooks import sendLoginWebhook, sendPromptWebhook
from threading import Thread
import requests
import base64
import csv
app = Flask(_{——}name_{——})
@app.after_request
def handle_options(response):
  response.headers[“Access-Control-Allow-Origin”] = “*”
  response.headers[“Access-Control-Allow-Methods”] = “GET,
  POST, PUT,
DELETE, OPTIONS”
  response.headers[“Access-Control-Allow-Headers”] =
  “Content-Type, X-
Requested-With”
  return response
@app.route(‘/login’, methods=[‘GET’])
def home( ):
  username = request.args.get(‘username’)
  password = request.args.get(‘password’)
  try:
    with open(‘users.csv’, newline=”) as csvfile:
      reader = csv.DictReader(csvfile)
      for row in reader:
        if row[‘USERNAME’].lower( ) == username.lower( ):
          if password == row[‘PASSWORD’]:
            print(“Matched”)
            key = b‘poopoo234islegitasfbrolikefullyv’
            iv = b“g4vhFlR1KncRlyvO”
            message = username + ‘:’ + password
            cipher = AES.new(key, AES.MODE_CBC, iv)
            ciphertext = cipher.encrypt(pad(bytes(message,
            ‘UTF-8’),
AES.block_size))
            print(f“Logged in sucessfully | Account {username}”)
```

```
        Thread(target=sendLoginWebhook, args=(username,
request.remote_addr, True)).start( )
        return str(base64.b64encode(ciphertext).decode(‘UTF-8’)), 200
      print(“Invalid login provided”)
      Thread(target=sendLoginWebhook, args=(username,
      request.remote_addr,
False)).start( )
      return ‘invalid’, 200
    except (Exception, ValueError) as e:
      print(“Invalid login provided ” + str(e))
      return ‘invalid’, 200
        Also, non-limiting computer code examples for the template in
accordance with the present disclosure is shown below, which is also
include by way of example of only,
# $template->prompt is a format created explicitly for each agency based
on the state they opperate in and according to their industry standard
if ($variables = $request->variables) {
    foreach ($variables as $key => $value) {
      $response = str_replace($key, $value, $response);
    }
}
$prompt = str($template->prompt)->replace(‘DESCRIPTION_HERE’,
$request[‘incident_details’]);
$chatPrompt = [‘role’ => ‘user’, ‘content’ => $prompt];
$result = OpenAI::chat( )->create([
    ‘model’ => ‘gpt-3.5-turbo-16k’,
    ‘max_tokens’ => 1000,
    ‘messages’ => [
      $chatPrompt
    ]
]);
$response = $result->choices[0]->message->content;
# Swapping personal information
# Variables contains user defined fields.
# These fields have a second value which contains the personal
information that will be displayed after the client generated their response.
if ($variables = $request->variables) {
    foreach ($variables as $key => $value) {
      $response = str_replace($key, $value, $response);
    }
}
$data = [
  ‘input’ => $prompt,
  ‘report’ => $response,
  ‘case_nr’ => $request[‘case_number’],
  ‘user_id’ => Auth::user( )->id
];
$report = Report::create($data);
$fileName = $request[“case_number”].“.txt”;
$fileStorePath = public_path(‘/reports/’.$fileName);
File::put($fileStorePath, $response);
$destination = public_path(‘/reports/’);
$pathToFile = $destination.$fileName;
return [
    “filename” => $fileName,
    “filepath” => $pathToFile,
    ‘report_id’ => $report->id,
    ‘data’ => $response
```

It should be recognized that all of the steps described above performed in creating the incident reports from the initial login steps can be performed by software, web-based applications, LLM, etc. residing on a single computer system, including, but not limited to, a server (local, remote, cloud-based, etc.) or alternatively certain steps can be performed by software, web-based applications, LLM, etc. residing one computer system/server, while other steps described above can be performed by one or more different computer systems/servers such that the system distributed and not performing all steps from a single computer system and the above-configurations and other distributed system configurations can also be used and all are considered within the scope of the disclosure. As a non-limiting example of a distributed system configuration, the login steps performed by the web-based application can be operated located or hosted at one location and the audio extracting and report generation and checking can be performed by a software program or LLM located or hosted at a different location which can digitally/electronically receive the uploaded and/or entered information from the web-based application, where the information is uploaded/entered by the user using his or her electronic device having the webs-based application displayed on the screen of the electronic device.

Though not limiting, the system can be a system for creating comprehensive police reports, EMS reports or other agency/organization reports through the utilization of artificial intelligence (in one non-limiting embodiment), the system can comprise, without limitation:
a. A data input interface from which a user can enter a synopsis of the incident, such as the date, time, location, involved parties, witnesses, body camera footage, or other evidence or incident details;
b. An artificial intelligence prompt engine to capture relevant data from an officer-generated written synopsis and present context-relevant questions and prompts to the user based incident information within the synopsis and/or from body camera information; and
c. A report engine which compiles the entered data into a cohesive, comprehensive, standardized and/or customizable police report.

It should be understood, of course, that the foregoing relates to exemplary embodiments of the disclosed system and method and that modifications may be made without departing from the spirit and scope of the disclosure as set forth in the following claims.

What is claimed is:

1. A method for electronically creating an incident report concerning an incident, comprising:
a. electronically receiving a recording having an audio component by a server where the recording is digitally uploaded by a user using an electronic device;
b. directly transcribing data contained in the audio component of the recording by a software program running on the server;
c. creating a digital data transcription of the audio;
d. electronically forwarding the digital data transcription to the electronic device of the user for display on a screen associated with the electronic device;
e. receiving an approval from the user of the digital data transcription displayed on the screen or edits to the digital data transcription where the approval or edits are entered by the user using the electronic device; and
f. generating an incident report by the server based at least partially on information contained in the data transcription approved by the user.

2. The method for electronically creating an incident report of claim 1 further comprising the step of receiving a text description of the incident from the user by the server prior to step f.; wherein the user uses a user interface displayed on the screen of the electronic device to enter the text description; wherein the incident report generated in step f. is also at least partially based on the text description entered by the user.

3. The method for electronically creating an incident report of claim 1 further comprising the step of digitally integrating the incident report or digitally copy and pasting the incident report into a record management system of an organization or agency associated with the user.

4. The method for electronically creating an incident report of claim 1 further comprising the step of running a web-based application or program on a server or computer system for initiating a digitally generated incident reports.

5. The method for electronically creating an incident report of claim 1 wherein the server is a cloud-based server.

6. The method for electronically creating an incident report of claim 4 further comprising the step of receiving login information by the web-based application entered or uploaded by the user from the electronic device wherein the login information includes an encryption key or other data that identifies a specific organization that the user is preparing the incident report for.

7. The method for electronically creating an incident report of claim 6 further comprising identifying preexisting requirements set forth by the specific organization for an incident report related to the incident based on the identification of the specific organization from the received encryption key or other data.

8. The method for electronically creating an incident report of claim 1 further comprising displaying a preexisting template selected by the user on the screen associated with the electronic device for the user to enter or upload information concerning the incident.

9. The method for electronically creating an incident report of claim 7 further comprising the step of identifying specific requirements of the specific organization for an incident report concerning the incident.

10. The method for electronically creating an incident report of claim 9 further comprising the step of confirming by the software application running on the server that the incident report generated in step f contains or satisfies all of the specific requirements of the specific organization for the incident.

11. The method for electronically creating an incident report of claim 1 wherein the recording is a video recording and further comprising the step of digitally extracting the audio from the video recording prior to transcribing in step b.

12. The method for electronically creating an incident report of claim 11 wherein the video recording is a bodycam video recording.

13. The method for electronically creating an incident report of claim 12 wherein the incident report is a police report or EMS report.

14. The method for electronically creating an incident report of claim 6 further comprising displaying a choice of preexisting modules or prompts by the web-based application on the screen associated with the electronic device; wherein the preexisting modules or prompts are customized for the specific organization digitally identified in the encryption key or other data uploaded or entered by the user.

15. The method for electronically creating an incident report of claim 14 further comprising the step of receiving by the web-based application a digital selection of a module or prompt from the displayed choice of modules or prompts by the user.

16. The method for electronically creating an incident report of claim 14 further comprising the step of displaying a specific online template on the screen associated with the electronic device by the web-based application based on the digital selection received from the user for use by the user to enter or upload information and data for use in creating the incident report.

17. The method for electronically creating an incident report of claim 14 wherein the choice of modules or prompts are customized to the activities and functions of the specific organization identified in the received encryption key or other data entered or uploaded by the user.

18. The method for electronically creating an incident report of claim 16 wherein the specific online template is a preexisting template already customized to any requirements set forth by the specific organization for an incident report for the incident selected in the digital selection by the user.

19. A method for electronically creating a police or EMS report concerning an incident, comprising:
a. receiving login information by a web-based application entered or uploaded by the user from an electronic device where the web-based application is displayed on a screen associated with the electronic device; wherein the login information includes an encryption key or other data that identifies a specific organization that the user is preparing the incident report for;
b. displaying a preexisting template digitally selected by the user on the screen associated with the electronic device for the user to enter or upload information and data concerning the incident
c. electronically receiving a recording having an audio component by a server where the recording is initially digitally uploaded by a user using the displayed preexisting template to the web-based application;
d. directly transcribing data contained in the audio component of the recording by a software program running on the server;
e. creating a digital data transcription of the audio;
f. electronically forwarding the digital data transcription to the electronic device of the user for display on a screen associated with the electronic device;
g. receiving an approval from the user of the digital data transcription displayed on the screen or edits to the digital data transcription where the approval or edits are entered by the user using the electronic device;
h. receiving a text description of the incident from the user by the server; wherein the user uses a user interface displayed on the screen of the electronic device to enter the text description; and
i. generating an incident report by the server based at least partially on information contained in the data transcription approved by the user and the text description of the incident received from the user.

20. The method for electronically creating an incident report of claim 19 further comprising the step of digitally integrating the incident report or digitally copy and pasting the incident report into a record management system of an organization or agency associated with the user.

21. The method for electronically creating an incident report of claim 19 further comprising identifying preexisting requirements set forth by the specific organization for an incident report related to the incident based on the identification of the specific organization from the received encryption key or other data and confirming by the software application running on the server that the incident report generated in step i. contains or satisfies all of the specific requirements of the specific organization for the incident.

22. The method for electronically creating an incident report of claim 19 wherein the recording is a video recording and further comprising the step of digitally extracting the audio from the video recording prior to transcribing in step d.

23. The method for electronically creating an incident report of claim 19 further comprising displaying a choice of preexisting modules or prompts by the web-based application on the screen associated with the electronic device prior to step b.; wherein the preexisting modules or prompts are customized for the specific organization digitally identified in the encryption key or other data uploaded or entered by the user.

24. The method for electronically creating an incident report of claim 23 further comprising the step of receiving by the web-based application a digital selection of a module or prompt from the displayed choice of modules or prompts by the user resulting in the display of the preexisting template in step b.

25. The method for electronically creating an incident report of claim 19 wherein the choice of modules or prompts are customized to the activities and functions of the specific organization identified in the received encryption key or other data entered or uploaded by the user.

26. The method for electronically creating an incident report of claim 19 wherein the preexisting template already customized to any requirements set forth by the specific organization for an incident report for the incident selected in the digital selection by the user.

27. The method for electronically creating an incident report of claim 19 wherein the recording is a video recording and further comprising the step of digitally extracting the audio from the video recording prior to transcribing in step d.

28. A method for electronically creating a police or EMS report concerning an incident, comprising:
a. receiving login information by a web-based application entered or uploaded by the user from an electronic device where the web-based application is displayed on a screen associated with the electronic device; wherein the login information includes an encryption key or other data that identifies a specific organization that the user is preparing the incident report for;
b. displaying a choice of preexisting modules or prompts by the web-based application on the screen associated with the electronic device where the preexisting modules or prompts are customized for the specific organization digitally identified in the encryption key or other data uploaded or entered by the user in step a.
c. receiving by the web-based application a digital selection of a module or prompt from the displayed choice of modules or prompts by the user;
d. displaying a preexisting template on the screen associated with the electronic device based on the digital selection by the user in step c. for the user to enter or upload information and data concerning the incident
e. electronically receiving a video recording having an audio component by a server where the recording is initially digitally uploaded by a user using the displayed preexisting template to the web-based application;
f. digitally extracting the audio component from the video recording;
g. directly transcribing data contained in the audio component of the recording by a software program running on the server;
h. creating a digital data transcription of the audio;
i. electronically forwarding the digital data transcription to the electronic device of the user for display on a screen associated with the electronic device;
j. receiving an approval from the user of the digital data transcription displayed on the screen or edits to the digital data transcription where the approval or edits are entered by the user using the electronic device;
k. receiving a text description of the incident from the user by the server; wherein the user uses a user interface displayed on the screen of the electronic device to enter the text description; and
l. generating an incident report by the server based at least partially on information contained in the data transcription approved by the user and the text description of the incident received from the user.

29. The method for electronically creating an incident report of claim 28 further comprising the step of digitally integrating the incident report or digitally copy and pasting the incident report into a record management system of an organization or agency associated with the user.

30. The method for electronically creating an incident report of claim 28 further comprising identifying preexisting requirements set forth by the specific organization for an incident report related to the incident based on the identification of the specific organization from the received encryption key or other data and confirming by the software application running on the server that the incident report generated in step i. contains or satisfies all of the specific requirements of the specific organization for the incident.
